(19) United States
(12) Patent Application Publication
(10) Pub. No.: US 2008/0073039 A1
(43) Pub. Date: Mar. 27, 2008

(54) Roller blind arrangement

(76) Inventors: Allan Gyngell, Davisburg, MI (US); Dennis Bowles, Fenton, MI (US)

Correspondence Address: FLYNN THIEL BOUTELL & TANIS, P.C., 2026 RAMBLING ROAD, KALAMAZOO, MI, 49008-1631, US

(21) Appl. No.: 11/903,739

(22) Filed: Sep. 24, 2007

Related U.S. Application Data
(60) Provisional application No. 60/846,973, filed on Sep. 25, 2006.

(30) Foreign Application Priority Data
Sep. 25, 2006 (DE) 10 2006 046 440.0

(51) Int. Cl. E06B 9/56; E06B 9/58

(52) U.S. Cl. 160/313; 160/315

(57) ABSTRACT

The invention relates to a roller blind arrangement, in particular for use in a vehicle, with a winding shaft (10) which extends in a main direction of extent (2), is in the form of a hollow tube and is intended for receiving an unwindable flexible sheetlike structure, a winding spring (12) which is inserted into the winding shaft (10), is designed as a helical spring and extends in the main direction of extent, and a damping profile (20) which extends in the main direction of extent (2) and is arranged in an annular space (16) between the winding shaft (10) and the winding spring (12).

According to the invention, the damping profile (20) is designed in such a manner that it bears with outer contact sections (24) against an inner side of the winding shaft (10) and with inner contact sections (22) against an outer side of the winding spring (12).

Use, in particular roller blind arrangements in vehicles, for example for coverings of the boot.

### CROSS-REFERENCE TO RELATED APPLICATIONS

This application claims the benefit of U.S. Provisional Application No. 60/846,973, filed Sep. 25, 2006 and Germany Application No. 10 2006 046 440.0, filed Sep. 25, 2006, which are incorporated herein in their entirety.

### FIELD OF APPLICATION AND PRIOR ART

The invention relates to a roller blind arrangement which is provided in particular for use in a vehicle, with a winding shaft which extends in a main direction of extent, is in the form of a hollow tube and is intended for receiving an unwindable flexible sheetlike structure, a winding spring which is inserted into the winding shaft, is designed as a helical spring and extends in the main direction of extent, and a damping profile which extends in the main direction of extent and is arranged in an annular space between the winding shaft and the winding spring. The invention relates in particular also to roller blind arrangements in which a spring rod which extends in the main direction of extent is inserted into the winding spring.

Roller blind arrangements of this type are known from DE 29 41 711 C2. In these known roller blind arrangements, tubes are provided between a torsion spring, on the one hand, and an external roller or an internal shaft and in each case bear against the inner side or the outer side of a torsion spring. The purpose of said tubes is to damp annoying noises which arise during the twisting of the torsion spring.

A disadvantage of the roller blind arrangement is that, although they damp the sound, they do not prevent the torsion spring from striking against the roller blind wall or against the shaft.

### PROBLEM AND SOLUTION

It is the problem of the invention to provide a roller blind arrangement in which the sound which arises within the roller blind arrangement during operation and penetrates to the outside is reduced.

According to the invention, a roller blind arrangement of the type in question is proposed, in which the damping profile is designed in such a manner that it bears with outer contact sections against an inner side of the winding shaft and with inner contact sections against an outer side of the winding spring. With regard to the production of noise due to the interaction of the winding spring and the spring rod, a roller blind arrangement of the type in question is proposed, in which the damping profile is designed in such a manner that it bears with outer contact sections against an inner side of the winding spring and with inner contact sections against an outer side of the spring rod.

Roller blind arrangements of the type in question serve, in particular, to store a flexible sheetlike structure while it is not in use and to retract the flexible sheetlike structure in order to transfer it from a state of use into a not-in-use state. In the retracted state, the sheetlike structure is preferably rolled up in a number of layers on the winding shaft. During the manual extension of the sheetlike structure, the winding spring is twisted such that it exerts a restoring force on the extended part of the sheetlike structure.

Changes in the state of torsion of the winding spring, i.e. in particular the manual unwinding of the sheetlike structure and the automatic retraction of the sheetlike structure, and also shaking of the roller blind arrangement, may result in a force occurring which acts radially on the winding spring and deflects the winding spring out of its starting position. Furthermore, shaking introduced from the outside may also result in the winding spring being deflected. The deflections of the winding spring result in annoying noises which arise, in particular, when the outer side of the winding spring strikes against the inner side of the winding shaft and when the inner side of the winding spring strikes against the outer side of the spring rod. By means of the damping profile which is provided according to the invention, bears on the inside and outside in a play-free or largely play-free manner, and, depending on the intended use, is provided in the annular space between the winding spring and the winding shaft or else in the annular space between the winding spring and the spring rod, a hard striking of the winding spring on the inner side of the winding shaft or on the outer side of the spring rod is prevented. The damping profile firstly prevents direct contact between the winding spring, on the one hand, and the winding shaft or the spring rod, on the other hand. Secondly, the damping profile also prevents free and unbraked deflection of the winding spring and the associated hard striking on the inner side of the winding shaft or on the outer side of the spring rod.

The damping profile is preferably manufactured from elastic materials, such as plastic or rubber, which permit a small deflection of the winding spring out of its starting position, since such a deflection may occur during the twisting of the winding spring. In addition to the selection of material, the configuration of the cross section of the damping profile is preferably also designed in such a manner that a limited deflection of the winding spring remains possible.

The damping profile extends in the main direction of extent parallel to the winding shaft and to the winding spring. Embodiments are preferred in which the damping profile extends over the entire length of the winding spring. However, embodiments may also be expedient, in which the damping profile is provided only on partial sections of the winding spring, said partial sections preferably only being spaced apart from one another to an extent such that striking of the winding spring against the winding shaft or against the spring rod is also prevented in the sections situated in between.

In a development of the invention, in the case of a damping profile which is arranged between the winding spring and the winding shaft, a cross section of the damping profile is designed in such a manner that the damping profile bears in at least one contact region against the outer side of the winding spring and is spaced apart in at least one loose region from the outer side of the winding spring. In the case of a damping profile which is arranged between the winding spring and the spring rod, the cross section is designed, according to this development, in such a manner that the damping profile bears in at least one contact region against the inner side of the winding spring and is spaced apart in at least one loose region from the inner side of the winding spring.

Accordingly, a damping profile of this type bears against the winding spring only in the contact sections rather than over its full circumference. As a result, over the course of the torsion or over the course of shaking, the winding spring can be deflected by a low extent into the loose region. This is advantageous in particular with regard to the torsion, since a deflection to a limited extent is normal during the twisting of the winding spring. If this twisting is completely prevented, this leads to an increase in the extension force which is to be applied manually.

Particularly advantageous are damping profiles, the contact sections of which bear against the winding spring in contact regions which, with regard to their dimensioning and/or arrangement on the circumference, are suitable for securely fixing the winding spring when relaxed in an undeflected rest position.

In a development of the invention, the damping profile is designed in such a manner that it bears against the winding spring in three contact regions, with a respective loose region lying between the contact regions.

The contact regions are preferably distributed uniformly over the circumference of the winding spring. The embodiment with three contact regions enables good positional fixing of the winding spring to be achieved when it is not deflected radially.

In a development of the invention, the damping profile is designed as a hollow damping profile.

A hollow damping profile of this type is closed peripherally such that direct contact between the winding spring, on the one hand, and the spring rod or the winding shaft, on the other hand, is reliably prevented. Furthermore, the design as a hollow damping profile also has advantages with regard to the installation, since the winding spring can be pushed in a simple manner into the damping profile and the damping profile can subsequently be pushed with the winding spring pushed into it into the winding shaft. The installation of a damping profile which is arranged between winding spring and spring rod is also correspondingly simple.

In a development of the invention, the damping profile has a plurality of profile segments which extend in the main direction of extent and are at least not connected to one another over the full length of the damping profile in a circumferential direction.

A damping profile of this type with separate profile segments preferably has profile segments which are distributed at regular distances in the circumferential direction around the winding spring or around the spring rod. In this case, the inner and outer contact sections are preferably arranged in such a manner that each profile segment has at least one inner and at least one outer contact section. As an alternative thereto, embodiments are also conceivable and, depending on the boundary conditions, expedient, in which profile segments are provided with inner contact sections and other profile segments are provided with outer contact sections. Profile segments with a round cross section are particularly advantageous.

The profile segments are connected to one another in the region of a connecting section, these connecting sections preferably being provided on the end sides of the damping profile. In order to increase the positional stability of the profile segments, it may also be expedient to provide a plurality of connecting sections which are preferably spaced apart regularly from one another in the main direction of extent. The advantage of the use of a damping profile with profile segments which are not connected over the full length in the circumferential direction resides, in particular, in the saving on material and the reduction in weight. In a development of the invention, the cross section of the damping profile is designed in such a manner that a radial displacement of an inner or outer contact section results in a radial displacement, which acts in the same direction, of an opposite outer or inner contact section.

In this context, a displacement in the same direction is understood as meaning a displacement which is likewise effective radially outwards or is likewise effective radially inwards. In the fitted state of the damping profile, such a configuration of the damping profile results in the contact sections, which bear against the winding shaft or the spring rod, being pressed against the winding shaft or against the spring rod as a reaction to a deflection of the winding spring, which action preferably leads to deformation of the damping profile in the region of the outer contact sections. Configurations are in particular preferred, in which a deflection of the winding spring against various contact sections bearing over the circumference on the winding shaft side or spring rod side leads to increased contact pressure. In a development of the invention, the cross section of the damping profile is designed in such a manner that a radial displacement of an inner or outer contact section results in a displacement at least of one other inner or outer contact section.

In such a refinement, the deflection of the winding spring and the associated deflection of a contact section bearing against the winding spring lead to the other contact sections which bear against the winding spring also being displaced. The displacement takes place here in the circumferential direction and/or in the radial direction. As a result, even in the deflected state, the winding spring remains in contact with a plurality of contact sections, which bear against it, of the damping profile, and therefore a return of the winding spring into its starting position does not lead to the damping profile and the winding spring striking against each other. The result is a reduced production of noise.

In a development of the invention, the damping profile is designed as a damping tube with a polygonal cross section, the cross section having concave indentations which comprise the inner contact section, and convex bulges which comprise the outer contact sections.

In this case, a damping tube with a polygonal cross section is understood as meaning a damping tube with a wall with an approximately uniform wall thickness, the cross section of which is not circular but rather the cross section of which has a shaping which has subregions in which the wall is in contact with the winding spring, and other subregions in which the wall is in contact with the winding shaft or the spring rod. These contact sections are of concave or convex design. Embodiments with in each case three or more convex outer contact sections and concave inner contact sections are particularly preferred. In the case of such a damping profile, a radial displacement of one contact section can lead to a displacement of adjacent contact sections, and therefore the contact between all of the contact sections and the winding spring is maintained.

In a development of the invention, the damping profile is designed as a damping tube with a preferably circular cross section and with contact webs which emerge from the damping tube and point radially inwards and/or radially outwards, the inner and the outer contact sections being provided in each case at distal ends of the contact webs.

In this case, the use of contact sections which can be deformed elastically is particularly preferred. This is advantageous both with regard to the deflection of the winding spring and with regard to the use of one and the same damping profile type for various winding rollers, winding springs and/or spring rods.

In a development of the invention, in the non-fitted state, the damping profile has a smaller inside diameter and/or a larger outside diameter than the annular space in which it is arranged in the fitted state.

In the fitted state, such a damping profile is deformed elastically, and therefore, when the winding spring is deflected in the radial direction, the contact sections which face away from the deflection are guided in the direction of their relaxed state and thus remain in contact with the winding spring.

### BRIEF DESCRIPTION OF THE DRAWINGS

Further features of the invention emerge from the embodiments of the invention which are illustrated in the figures and described below. In the drawings:

FIGS. 1a to 1c show a first embodiment of a roller blind arrangement according to the invention with a damping profile in a perspective, sectioned illustration and in various sectioned side views with the winding spring deflected and not deflected,

FIGS. 2a to 2c show a second embodiment of a roller blind arrangement according to the invention with a damping profile in a perspective sectioned illustration and in various sectioned side views with the winding spring deflected and not deflected,

FIG. 3 shows a third embodiment of a roller blind arrangement according to the invention in a sectioned side illustration,

FIGS. 4a and 4b show a fourth embodiment of a roller blind arrangement according to the invention in two sectioned side illustrations with the winding spring deflected and not deflected,

FIGS. 5a and 5b shows a fifth embodiment of a roller blind arrangement according to the invention in two sectioned side illustrations with the winding spring deflected and not deflected,

FIGS. 6a and 6b show a sixth embodiment of a roller blind arrangement according to the invention in two sectioned side illustrations with the winding spring deflected and not deflected, and

FIG. 7 shows a seventh embodiment of a roller blind arrangement according to the invention in a sectioned side illustration.

### DETAILED DESCRIPTION OF THE DRAWINGS

The illustrated embodiments of roller blind arrangements according to the invention each only show the winding shaft together with the winding spring, the damping element and some together with the spring rod. The remaining components of the roller blind arrangements, such as, for example, the flexible sheetlike structure or a surrounding housing, are not illustrated for reasons of clarity.

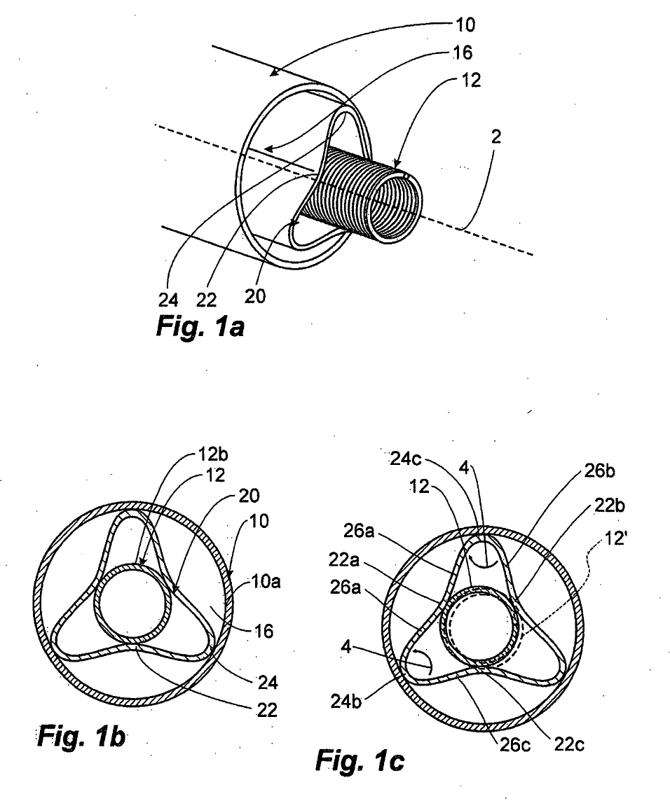

FIG. 1a shows the basic construction using the example of a first embodiment of the winding shaft of a roller blind arrangement according to the invention: a winding spring 12 is arranged within the winding shaft 10, the winding shaft 10 and the winding spring 12 having a common main direction of extent 2. A damping profile 20 is inserted in an annular cavity 16 between the winding shaft 10 and the internal winding spring 12, said damping profile bearing, in each case in a play-free manner, with inner contact sections 22 against the winding spring and with outer contact sections 24 against the winding shaft 12.

FIG. 1b shows the winding shaft 10 illustrated in FIG. 1a together with the inserted winding spring 12 and the damping profile 20 in a sectioned side view. The damping profile 20 bears with its outer contact sections 24—as described above—against an inner wall 10a of the winding shaft 10. The outer damping profile 20 bears with its inner contact sections 22 against the outer side 12b of the winding spring 12. The three inner contact sections and the three outer contact sections 24 are arranged in an alternating manner on the circumference of the damping profile 20. The cross section of the damping profile 20 has a polygonal, approximately trifurcated form, the outer contact sections 24 being arranged in the region of the rounded points and the inner contact sections 22 being arranged between the points. In the region of the outer contact sections 24, the outer damping profile 20 is of convex design and, in the region of the inner contact sections 22, is of concave design.

The configuration illustrated ensures particularly quiet operation. The damping profile is very light because of its thin-walled and simple configuration and can be produced favorably. The winding spring 12 is kept in its position illustrated in FIGS. 1a and 1b by the damping profile 20 but, nevertheless, can be deflected to the extent required for correct torsion owing to the fact that the damping profile 20 is composed of an elastic material, and owing to the shaping of the damping profile 20.

Direct contact of the winding spring 12 with the winding shaft 10 is prevented by the damping profile 20 as is a high radial acceleration of the winding spring, for example as a result of shaking.

FIG. 1c shows the behavior of the damping profile 20 in the event of a radial deflection of the winding spring 12. In the state illustrated, the winding spring is deflected to the left by a small distance, with the starting position 12′ being illustrated by dashed lines. The deflection leads to an inner contact section 22a which bears against said spring likewise being deflected radially outwards. As a reaction thereto, connecting sections 26a of the damping profile 20, which connect the inner contact section 22a to the adjacent outer contact sections 24b, 24c, are pivoted about the adjacent outer contact sections 24b, 24c. This results in the outer contact sections 24b, 24c being rotated slightly in the direction of the arrows 4. This in turn leads to a corresponding rotation of the connecting sections 26b, 26c lying opposite the connecting sections 26a, the connecting sections 26b, 26c thereby bringing about a radially inwardly facing guidance of the inner contact sections 22b, 22c. The effect achieved by this is that, even in this deflected state of the winding spring 12, all three contact sections 22a, 22b, 22c bear against the outer side 12b of the winding spring 12. This continuous guidance, which ensures constant contact of the inner sections 22a, 22b, 22c of the damping profile 20 with the winding spring 12 at least upon only slight shaking, prevents undesirable noises, such as clattering or rattling.

In the embodiment of FIGS. 1a to 1c, a dimensioning of the damping profile 20, in which the outside diameter of the damping profile 20, which diameter is defined by the outer contact sections 24a, 24b, 24c, is larger in the non-fitted state than the inside diameter of the winding shaft 10 is particularly advantageous. The elastically stressed state which can thereby be achieved in the fitted state additionally assists the above-described guidance.

In the case of variations (not illustrated) of this first embodiment, the cross section of the damping profile is designed in the manner of a peripheral rectangular function, in which circumferential sections bear in an alternating manner on the inside against the winding spring and on the outside against the winding shaft, the circumferential sections being connected to one another by radial connecting sections.

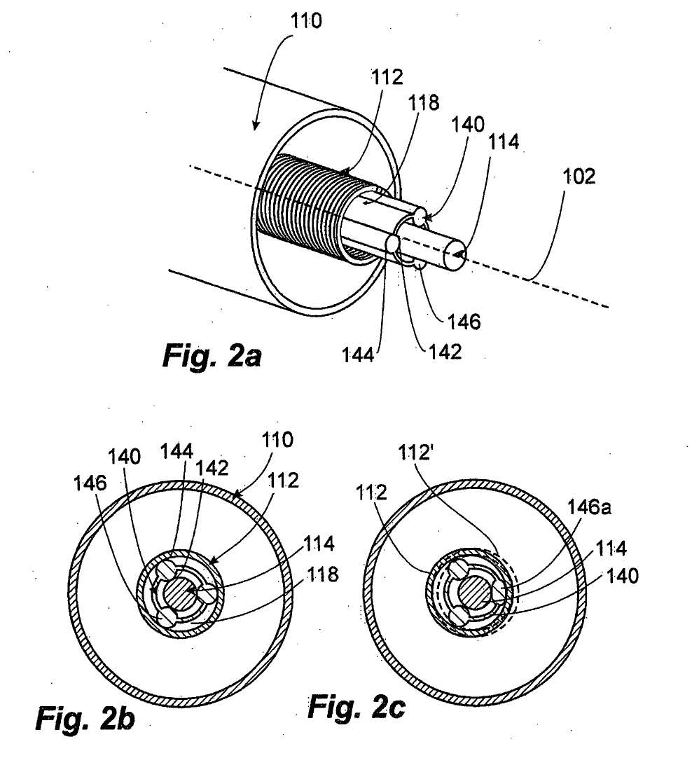

FIGS. 2a to 2c show a winding shaft of a second embodiment of a roller blind arrangement according to the invention. A winding spring 112 is arranged within the winding shaft 110. This winding spring 112, which is designed as a helical spring, is restricted with regard to its radial mobility by means of a spring rod 114 which is inserted into the winding spring 112. A damping profile 140 is arranged in an annular space 118 between the winding spring 112 and the spring rod 114. The winding shaft 110, the winding spring 112, the spring rod 114 and the damping profile 140 extend parallel to one another in a main direction of extent 102.

The damping profile 140 is designed as a damping tube with an approximately circular cross section, with a total of three thickened portions 146 being distributed over the circumference. The thickened portions 146 extend radially inwards and outwards from the damping tube, said thickened portions forming inner contact sections 142 and outer contact sections 144. The damping profile 140 bears with the inner contact sections 142 against the spring rod 114, and the damping profile 140 bears with the outer contact sections against the winding spring 112.

FIG. 2c shows the manner in which the damping profile 140 behaves when the winding spring 112 is deflected out of its starting position 112′. In this case, the damping profile 140 prevents direct contact between the spring rod 114 and winding spring 112. A thickened portion 146a is compressed elastically by the deflection. As a result, although the damping profile 140 permits deflection of the winding spring, it presses the winding spring back again into its starting position. The winding spring 112 and the spring rod 114 are always in indirect contact with each other via at least one of the thickened portions 146.

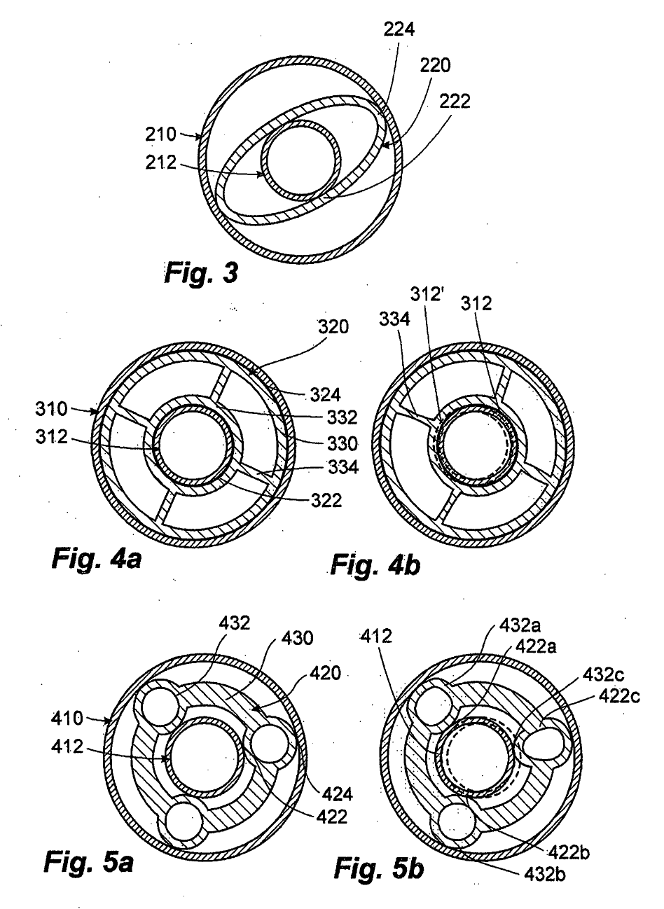

FIGS. 3 to 7 show cross sections of further damping profiles which are arranged between winding shafts 210, 310, 410, 510, 610 and winding springs 212, 312, 412, 512, 612. However, these damping profiles may also be used in the same or a correspondingly adapted form between spring rods and winding springs. Unless indicated otherwise, the damping profiles have the respectively illustrated cross section over their entire length.

FIG. 3 shows a particularly simple configuration of a damping profile 220 of a roller blind arrangement according to the invention. This damping profile 220 has an approximately oval cross section and in each case two outer contact sections 224 bearing against the winding shaft 210 and two inner contact sections 222 bearing against the winding spring 212. Such a damping profile 220 is advantageous in particular on account of the low weight, the simple construction and the associated low costs.

FIGS. 4a and 4b show a damping profile 320 which comprises an outer tube 330 and an inner tube 332 which are connected to each other via connecting webs 334. The outer surface of the outer tube 330 forms the outer contact section 324 of the damping profile, and the inner side of the inner tube 332 forms the inner contact section 322. As a result of the fact that the inner tube 332 and the outer tube 330 are connected to each other only via narrow webs 334, a radial deflection of the winding spring 312 out of its starting position 312′ with simultaneous elastic extension or elastic compression of the connecting webs 334 is possible—as illustrated in FIG. 4b.

The damping profile 420 illustrated in FIGS. 5a and 5b is similar to the damping profile 40 of the embodiment of FIGS. 2a to 2c. It likewise has a circular tubular section 430 which has thickened portions 432 at three points spaced apart from one another in each case by 120°. These thickened portions 432 extend inwards and outwards from the circular cross section of the tube 430. The inwardly pointing sections of the thickened portions 432 form the inner contact sections 422. The outwardly pointing sections of the thickened portions 432 form the outer contact sections 424. In a departure from the embodiment of FIGS. 2a to 2c, hollow tubes are provided in the thickened portions 432, which is advantageous with regard to elastic deformation. In this embodiment, a deflection of the winding spring 412 out of the starting position leads—as illustrated in FIG. 5b—to two of the thickened portions 432a, 432b being compressed in the radial direction, which results, via the wall 430 of the tube 430, in a compression of the third thickened portions 432c in the circumferential direction and therefore in an extension of said thickened portions 432c in the radial direction. It is therefore ensured, even in the embodiment of FIGS. 5a and 5b, that at least relatively small deflections of the winding spring 412 are possible without the inner contact sections 422 losing contact with the outer side of the winding spring 412.

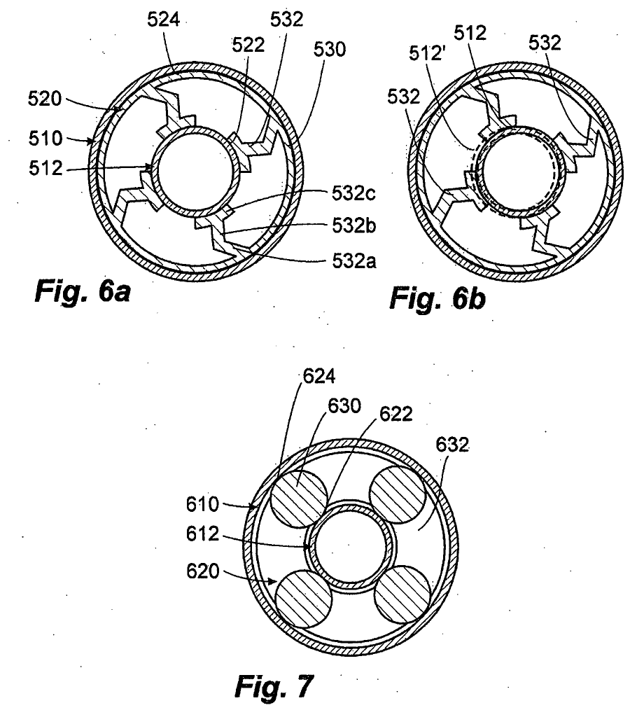

FIGS. 6a and 6b show an embodiment with a damping profile 520 which comprises a tubular section 530 bearing against the inner wall of the winding shaft 510 and four contact webs 532 extending inwards from the tubular section 530. In this case, the tubular section 530 forms an outer contact section 524. The contact webs 532 have inner and outer limbs 532a, 532b which are each angled with respect to each other. The inner limbs 532b each lead into an inner contact section 522 which is designed as concavely configured contact cups 532c for bearing against the winding spring 512. The contact webs 532 are preferably dimensioned in such a manner that they are prestressed elastically when the winding spring 512 is introduced. As soon as the winding spring 512 is deflected out of its starting position 512′, this leads to an increase in the elastic stressing of the contact web 532a which is arranged in the direction in which the deflection takes place, while the opposite contact web 532b undergoes elastic relaxation, but remains in contact with the winding spring 512.

FIG. 7 shows a damping profile 620 which has four profile segments 630 which are distributed over the circumference and are not connected to one another in the circumferential direction in the section plane of FIG. 7. The profile segments 630 have a respectively circular cross section, with the mutually facing sides of the profile segments 630 forming inner contact sections 622 which bear against a winding spring 612, and with those sides of the profile sections 630 which face away from one another forming outer contact sections 624 which bear against a winding shaft 610. Outside the section plane illustrated, the profile segments 630 are connected to one another via connecting webs 632, such connecting webs 632 being provided at least on the end sides of the damping profile. Furthermore, it is expedient to distribute further connecting sections 632 over the length of the damping profile. In addition to the saving on material which is associated with such a configuration of a damping profile, in such a damping profile the behavior during a deflection of the winding spring 612 is particularly advantageous. The profile segments 630 are movable to a limited extent in the circumferential direction, and they can therefore be deflected elastically out of their starting position illustrated in FIG. 7 with simultaneous compression. Expedient limited mobility of the winding spring 612 is therefore provided.

1. Roller blind arrangement, in particular for use in a vehicle, with
a winding shaft (10; 110; 210; 310; 410; 510; 610) which extends in a main direction of extent (2; 102), is in the form of a hollow tube and is intended for receiving an unwindable flexible sheetlike structure,
a winding spring (12; 112; 212; 312; 412; 512; 612) which is inserted into the winding shaft, is designed as a helical spring and extends in the main direction of extent, and
a damping profile (20; 220; 320; 420; 520; 620) which extends in the main direction of extent and is arranged in an annular space (16) between the winding shaft and the winding spring,
characterized in that
the damping profile is designed in such a manner that it bears with outer contact sections (24; 224; 324; 424; 524; 624) against an inner side of the winding shaft and with inner contact sections (22; 222; 322; 422; 522; 622) against an outer side of the winding spring.

2. Roller blind arrangement according to claim 1, characterized in that a cross section of the damping profile (20; 220; 420; 520; 620) is designed in such a manner that the damping profile
bears in at least one contact region against the outer side of the winding spring (12; 212; 412; 512; 612) and
is spaced apart in at least one loose region from the outer side of the winding spring.

3. Roller blind arrangement, in particular for use in a vehicle, with
a winding shaft (110) which extends in the main direction of extent (102), is in the form of a hollow tube and is intended for receiving an unwindable flexible sheetlike structure,
a winding, spring (112) which is inserted into the winding shaft, is designed as a helical spring and extends in the main direction of extent,
a spring rod (114) which is inserted into the winding spring (112) and extends in the main direction of extent, and
a damping profile (140) which extends in the main direction of extent and is arranged in an annular space (118) between the winding shaft and the winding spring,
characterized in that
the damping profile (140) is designed in such a manner that it bears with outer contact sections (144) against an inner side of the winding spring and with inner contact sections (142) against an outer side of the spring rod (114).

4. Roller blind arrangement according to claim 3, characterized in that a cross section of the damping profile (140) is designed in such a manner that the damping profile
bears in at least one contact region against the inner side of the winding spring (112), and
is spaced apart in at least one loose region from the inner side of the winding spring (112).

5. Roller blind arrangement according to one of claims 2 and 4, characterized in that the damping profile (20; 140; 420) is designed in such a manner that it bears in three contact regions against the winding spring, with a respective loose region lying between the contact regions.

6. Roller blind arrangement according to one of the preceding claims, characterized in that the damping profile (20; 140; 220; 320; 420; 520) is designed as a hollow damping profile.

7. Roller blind arrangement according to one of claims 1 to 5, characterized in that the damping profile (620) has a plurality of profile segments (630) which extend in the main direction of extent and are at least not connected to one another over the full length of the damping profile in a circumferential direction.

8. Roller blind arrangement according to claim 7, characterized in that the profile segments (630) are connected to one another at least on one end side by means of an encircling connecting web (632).

9. Roller blind arrangement according to one of the preceding claims, characterized in that the cross section of the damping profile (20) is designed in such a manner that a radial displacement of an inner or outer contact section (22, 24) results in a radial displacement, which acts in the same direction, of an opposite outer or inner contact section (24, 22).

10. Roller blind arrangement according to one of the preceding claims, characterized in that the cross section of the damping profile (20; 420) is designed in such a manner that a radial displacement of an inner or outer contact section (22a; 422a, 422c) results in a displacement of at least one other inner or outer contact section (22b, 22c; 422b).

11. Roller blind arrangement according to one of the preceding claims, characterized in that the damping profile (20) is designed as a damping tube with a polygonal cross section, the cross section
having concave indentations which comprise the inner contact section (22), and
convex bulges which comprise the outer contact sections (24).

12. Roller blind arrangement according to one of claims 1 to 10, characterized in that the damping profile (520) is designed as a damping tube (530) with a preferably circular cross section and with contact webs (532) pointing radially inward and/or radially outward from the damping tube (530), the inner and the outer contact sections (522) being provided in each case at distal ends (532c) of the contact webs (532).

13. Roller blind arrangement according to one of the preceding claims, characterized in that, in the non-fitted state, the damping profile (20; 520) has a smaller inside diameter and/or a larger outside diameter than the annular space (16) in which it is arranged in the fitted state.
